(19) United States
(12) Patent Application Publication
(10) Pub. No.: US 2009/0134980 A1
(43) Pub. Date: May 28, 2009

(54) SYSTEM, TOOLS, AND METHOD FOR GENERATING AND DISPLAYING ELECTRONIC MEMORIAL AND DEDICATION MEDIA, AND ADMINISTRATING COMMUNICATION AND LINKING OF USERS

(76) Inventor: Steve Katz, Southfield, MI (US)

Correspondence Address: KOHN & ASSOCIATES, PLLC, 30500 NORTHWESTERN HWY, SUITE 410, FARMINGTON HILLS, MI, 48334, US

(21) Appl. No.: 12/257,925

(22) Filed: Oct. 24, 2008

Related U.S. Application Data
(60) Provisional application No. 60/982,159, filed on Oct. 24, 2007.

(51) Int. Cl. G09F 19/00

(52) U.S. Cl. 340/286.01

(57) ABSTRACT

According to the present invention, there is provided a system and method for generating and displaying electronic notification and memorial media, including display tools for displaying notifications, memorials, and related information, administrative tools for managing the system's operation and the linking of users, communication tools for disseminating related memorial notifications and announcements, broadcast tools for enabling users to participate remotely in memorial and other activities and events, and tribute tools for further memorial activities. While preferably the system and method of the present invention are directed towards applications in the memorial/dedication field, the system and method of the present invention can also be adapted and applied to a broad range of settings and industries, wherever the communication and display of information and notifications is necessary.

### CROSS-REFERENCE TO RELATED APPLICATIONS

This application claims the benefit of priority under 35 U.S.C. Section 119(e) of U.S. Provisional Patent Application No. 60/982,159, filed Oct. 24, 2007, which is incorporated herein by reference.

### BACKGROUND OF THE INVENTION

1. Field of the Invention

The present invention generally relates to the field of electronic notifications, recognitions and memorials. Specifically, the invention relates to the areas of generating and displaying recognition media, and administrating the communication, notification, and linking of users interested in such notifications, recognitions and memorials.

2. Description of Related Art

Currently, when individuals go into most organizations, they find plaques of persons for whom sections of the organization or items found therein have been dedicated. In many circumstances there are numerous memorial boards with plaques containing the names of past members who have passed on. Unfortunately, unless an individual looking at the plaque is familiar with the individual being memorialized, and the location of the memorial, the memory of that individual will not truly live on.

The idea of recognizing individuals should not merely be fulfilled with the display of their names to those who have no appreciation of who those individuals were. As an example, to truly memorialize someone is to first know something about the individual, maybe even to know some of their accomplishments while they were living, and to then recognize that the world is less complete without them in our presence. We may even be able to glean some information that will help us direct or improve our own lives. A name alone cannot elicit the same effect.

With the advent of the internet, several online recognition sites, and most commonly memorial sites and products have been developed. They generally offer users the setting and resources to create a pleasant online memorial that can include text, pictures, audio, video and more. Many such sites also include guestbooks so that visitors can leave thoughts and memories. Some sites are also tied to genealogical search engines. These sites can be relatively inexpensive for self administered memorial page building or more expensive for memorial page building guidance. Many generate revenue through advertising, while others do so by selling the use of the application, annual fees, or selling services tied into the page building. However, a few significant problems and shortcomings exist with the current online memorial format:

Firstly, current online memorials are geared toward individuals. They are created by one individual in memory of another individual. If the creator wants others to see the memorial, he has to let them know it exists. This means communication has to go out to all those who he wishes to visit the site. They will likely not know it exists otherwise.

Secondly, those who visit the memorial without being directed there are effectively walking through an unknown graveyard and reading the tombstones. Guestbooks are frequently signed by individuals who “happened by” a memorial they were touched by. This is not a bad thing. The problem is that these visitors could have been walking through a known cemetery where at least they might come across people with whom the visitors have some kind of association—people who have the similar backgrounds, religious leanings, or simply lived nearby. Memorial sites that allow for searches of place of birth or place of burial may handle this better, but there is still a lack of a sense of community in the current system.

Additionally, the proceeds from the sale of memorial pages on typical memorial sites usually do not go to benefit people or organizations that were important to the deceased or survivors.

Furthermore, the current memorial systems develop independent databases that do not benefit outside groups. Organizations could benefit from the memorial data as well as the data about the relations of the deceased. Current memorial sites do not gather such information.

There are currently several common methods that organizations and institutions use to recognize individuals. Among the most common are donor boards, life cycle boards and memorial board plaques where dedications are displayed. We will use memorial boards to choose one example for the following points, but donor boards, life cycle boards or any other recognition board could be substituted. Memorial boards hold plaques contributed in memory of individuals. The plaques usually contain the name of the deceased and their date of death. They generally contain little if anything more. The plaques give no indication of when and where the individual was born, where they grew up, where they went to school, who they married, who they were related to, what contributions that individual made to society during their lives, etc.

Another method for memorializing an individual is donating books or other items used frequently within the organization. Such items generally contain a plate that shows the dedication of the item and usually even who dedicated it. However, even using this method, the depth of information about the deceased is not available. Also, these donations generally reside and remain within an organization and cannot be appreciated by friends and family who live in other parts of the world.

Larger scale memorial methods include dedicating a building or other such significant contributions. In these cases there is often a formal dedication, and speeches and literature are often prepared and presented about the deceased. However, while abundance of literature and speeches may be of value today, they do not have long term continuity. They fade away as soon as the dedication event is over. Other than a corner stone or plaque put up, there is often no further information presented or available about the deceased. Also, much like donated books, these donations are linked directly with a geographic site and cannot be appreciated as much from afar.

Another memorial method is the sponsorship of a program such as a lecture or lecture series, luncheon, or other such program, in memory of the deceased. These sponsorships are often well promoted and can include information on the deceased as well as on the donor families. This method of dedication may be narrow in scope, but usually hits a targeted audience and is very effective. In fact, the dedicated event may become an annual event where the individual would continue to be properly honored. Nevertheless, this method generally does not provide a constant memorial to the deceased.

Yet another method of memorializing an individual is through the dedication of a book or book issue in the deceased's memory. The dedicated books are often produced in large quantities and are used in numerous places, even beyond the organization where they may have been dedicated. The contribution by the deceased's family generally entitles them to put a page or plate in the books being dedicated, so the memorial is seen wherever the book is distributed. However, such dedications can be very costly, and generally only memorialize the deceased to those who have interest in the book or issue being dedicated.

Finally, the dedication of a scholarship or endowment is another method of memorializing an individual. While these types of dedications can provide wide exposure to the memory of the deceased if the scholarship is not exclusively awarded to local participants, the costs of such dedications are generally very high.

Thus, the currently available methods of memorializing an individual, while advantageous in some ways, generally fail to fully and consistently preserve the memory of the individual in a meaningful way to all those who knew the individual, or to those who could benefit from exposure to the individual's life and accomplishments. When a plaque, book, or building is dedicated in memory of someone, that item is fixed in some location and cannot be appreciated by others living elsewhere. Book issues and scholarships, while providing better exposure and providing an ongoing memorial, nevertheless can be costly and still may not be available to family all over the globe. Also, depending on a book issue's number of copies in a production run, the impact may be limited. If there is no reprinting done or if the reprinting is sponsored by a new party, the original dedication will diminish and eventually be impossible to find.

### SUMMARY OF THE INVENTION

According to the present invention, there is provided a system and method for generating and displaying electronic notification and memorial media, including display tools for displaying notifications, memorials, and related information, administrative tools for managing the system's operation and the linking of users, communication tools for disseminating related memorial notifications and announcements, broadcast tools for enabling users to participate remotely in memorial and other activities and events, and tribute tools for further memorial activities. While preferably the system and method of the present invention are directed towards applications in the memorial/dedication field, the system and method of the present invention can also be adapted and applied to a broad range of settings and industries, wherever the communication and display of information and notifications is necessary.

### DESCRIPTION OF THE DRAWINGS

Other advantages of the present invention are readily appreciated as the same becomes better understood by reference to the following detailed description, when considered in connection with the accompanying drawings wherein:

FIG. 1 is a depiction of the preferred embodiment of the present invention;

FIG. 2 is a depiction of one alternative embodiment of the present invention; and

FIG. 3 is a depiction of a second alternative embodiment of the present invention.

### DETAILED DESCRIPTION OF THE INVENTION

The present invention serves to create an environment whereby users are enabled to disseminate notifications and other related information to connected parties. In the preferred embodiment, the present invention enables users to respectfully honor the memory of a deceased family member, friend or associate. The present invention comprises an application, system, and method to build and manage the all-encompassing notification and memorial environment. The application allows users to create and view notifications and memorials, as well as to find direction and guidance in related topics, such as matters of death, dying and bereavement. It also enables users to administer memorializing or other such collaborative initiatives. The present invention is fully integrated and operable through all communication and broadcast mediums, primarily the internet, creating a global access portal for others to view notifications, memorial presentations and other information.

In the preferred embodiment, the system of the present invention further includes a notification system and method for communicating notification of deaths and memorials on behalf of the organizations that were important to the deceased and their loved ones. All collected information within the system is stored in a database, which is further used to guide other users to organizations, specialists or individuals that can help them cope with their losses. This mechanism assists organizations and their membership to see through their loss of loved ones and acquaintances and focus on the lives those individuals lived. In alternative embodiments, this system is used to notify users of important information and announcements. One such example is a teacher using the system to notify parents of upcoming assignments and class events. It should be noted that while the preferred embodiment of the present invention will be described with reference to a memorial system, the system and method of the present invention can be similarly applied to any other form of recognition board (such as a donor board, a life cycle board, etc.).

The present invention further includes a mechanism for allowing others to share information relating to specific items, events, and people referenced in the system. In the preferred embodiment, users are enabled to share their feelings and memories of the deceased in a respectful fashion, through cherished accounts, pictures, audio and video. This is accomplished via the creation of an electronic, multimedia repository for the eulogies and kind words, thoughts, and memories shared by family, friends and acquaintances of the deceased. This mechanism helps preserve the life and achievements of the deceased, so that history can appreciate how those who loved them viewed the individual. In alternative embodiments, this mechanism enables users to add additional information to a notification entry, further updating and enriching the system's data.

The present invention also provides users with the following tools:
In the preferred embodiment, a tool to facilitate donations to the sponsoring organization or other chosen organizations to further honor the memory of the departed. Alternative embodiments incorporate similar donation tools, as well as e-commerce storefront capabilities enabling users to buy and sell items directly through the site.
A broadcasting tool to broadcast events, meetings, funerals, etc. to those who are unable to physically attend.
A reminder tool to help remind the survivors of anniversaries of ones passing and other related and important events.
A communication tool to help communicate times and places of events, funerals, eulogies, memorials and more.
A support tool to help users and survivors find counseling and guidance as well as direct them to other helpful resources.

In the preferred embodiment, the present invention is best implemented in an organizational setting, allowing the organization to present the functionality and services of the present invention to their members as an extension of the services they already provide.

At the same time, the present invention introduces new notification and memorial opportunities to users. In the preferred embodiment of the present invention, members are enabled to memorialize a special departed individual at a local level or in a global venue through the internet, while contributing to an organization that has meaning to them or the deceased. They are able to contribute more information and visuals than if they simply put up a plaque on a memorial board or a simple tribute site. The memorial they design can be viewed locally at the organization, using the presentation tool of the present invention, or viewed anywhere through the internet.

In the preferred embodiment, the present invention also enables users to arrange for the web casting and/or broadcasting of funerals, eulogies, memorial services, lectures, etc., allowing friends and family all over the world to take part in the memorial. Alternative embodiments enable users to broadcast events, lectures, classes, and other items of interest.

The data collected by the present invention is also harnessed by the system to create and maintain a user network. In the preferred embodiment, this network facilitates genealogical searches for those building family trees or just looking for lost family members. In alternative embodiments, this network enables users to connect with other users who share similar interests, roles, jobs, etc.

The present invention further includes an administration tool which allows users to customize and modify the look, feel, and operation of the system to best fit the requirements of their organization or setting. Additionally, tools are provided for the administration and analysis of data and records pertaining to all aspects of the present invention.

### Display Tools

The display tool of the present invention serves as the onsite display presentation of the features and services of the present invention. The display tool operates through a software application which is connected to the system's server. In one embodiment, the system will be operatively connected to a central server, which stores all user data, and allows for far-reaching linking abilities between users. In an alternate embodiment, the server can reside locally, allowing for individual administrators to have additional control over the collection and storage of user data. In all embodiments, the server holds all data and information regarding the deceased and the memorial. The server is further connected to the internet, allowing all users to access the system and the data it contains. While essentially the same, the local display tool may be optionally modified to emphasize or de-emphasize certain features or functionalities, so that users will not spend too much time in front of the display interfacing with it, thereby allowing others to benefit from the display as well. Nevertheless, the local display tool is modifiable to allow for user input. In the preferred embodiment, users interact with the display tool to set up new memorial pages, load additional content to existing pages, submit requests and content for displayed notices and plaques, sign into guestbooks, and more. Similar administrator-defined functionalities are present in alternative embodiments as well.

The display tool of the present invention further enables the user to set up and broadcast or web cast events such as memorials to the deceased, lectures, classes, etc., both locally on the local display device, and remotely over the internet. The internet display method serves to allow users who are not able to personally attend an event or service to feel as though they are present.

The display tool of the present invention is enabled to operate over any display device such as a CRT, LCD, or plasma monitor or television, or any other such display device. The display properties of the present invention are fully customizable to allow for widescreen or portrait orientation. Furthermore, additional functionalities can be enabled if the system operates using a touch screen monitor. The monitor is also preferably enclosed safely, to preserve the display tools' integrity. Ideally, the local display tool would be mounted prominently on a wall where all users could easily view and interact with it.

In the preferred embodiment, the local display tool further includes an enclosure surrounding the monitor around the front and sides, as well as a back panel that could securely be mounted to a wall. On the front of the enclosure is a frame that will cover over and extend past the frame of the monitor screen, thereby framing the entire display. The frame would surround a Plexiglas window that would cover and protect the screen itself. Of course a touch screen would not have a Plexiglas front unless the touch screen is virtual with functionality derived from an apparatus that would project itself and be layered over the Plexiglas. The front frame is ideally hinged to allow for access to the monitor and internal wiring. Additionally, the enclosure will include a lock to secure the enclosure.

The sides, top and bottom of the enclosure ideally consist of a metal mesh or other forms of ventilation to protect the monitor while allowing for airflow to the monitor and other components encased in the enclosure. The bottom would be ventilated as well, but would include a support structure that is attachable to an optional base for a freestanding display tool.

In the preferred embodiment, the front of the enclosure (2) includes a built in keyboard (4), as depicted in FIG. 1. The keyboard allows users to navigate and interact with the system, including alphanumeric entry for searches and guestbook entry. Preferably, at the bottom of the display there is a 7″ lip (6) protruding from the front. This is used for a keyboard, and may be used for a mouse, touchpad or trackball as well. A soft keyboard can also be utilized and could be securely embedded into the protruding lip. A mouse, touchpad, or other such pointing device (8) is also included to allow users to navigate the system.

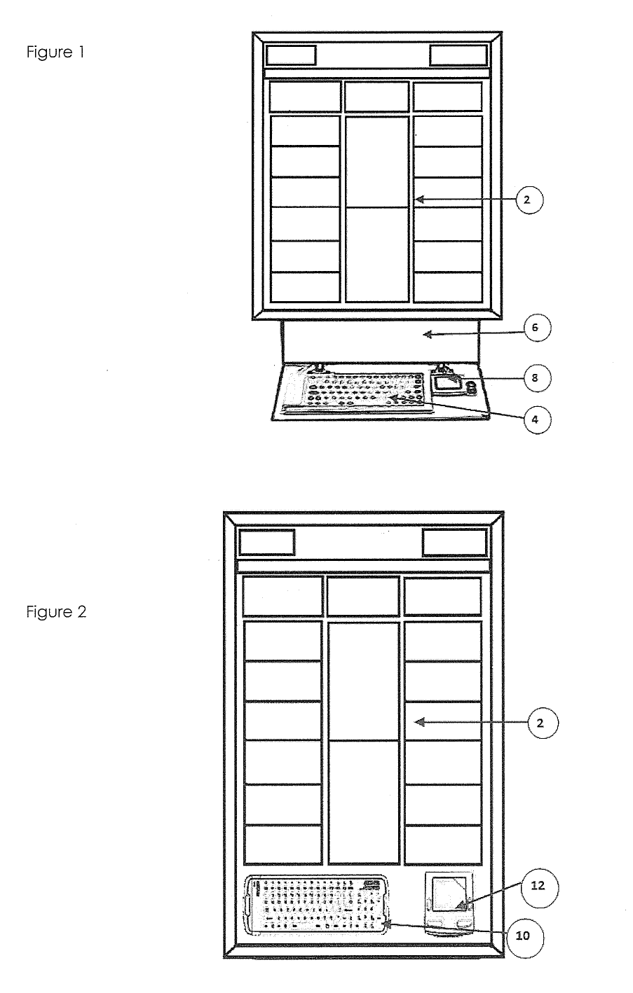

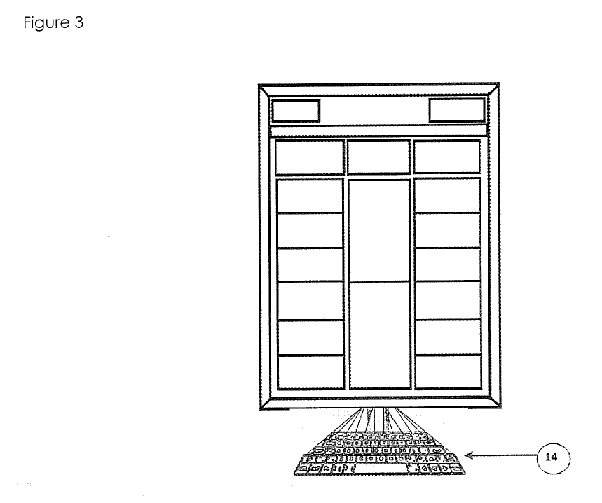

As depicted in FIG. 2, in one alternative embodiment, a smaller micro keyboard (10) and pointing device (12) is integrated into the display tool's frame (2), allowing the display enclosure to occupy less space.

In yet another embodiment, as depicted in FIG. 3, the display tool's keyboard is a virtual laser keyboard (14) that projects a keyboard image onto a flat surface. Flat surfaces include a lip beneath the enclosure that would jut out to accept the projected keyboard image, or the image may be projected onto the wall beneath the enclosure. Not only can the keyboard be virtual, but the mouse can be as well.

The display tool of the present invention further includes speakers for various audio related items such as: announcements, memorials, eulogies, music, etc. The speakers allow viewers to get the full appreciation of the system's content and presentation. In the preferred embodiment, the speakers are designed to be unobtrusive, blending into the look of the display tool. The speakers can further be enabled and disabled depending on the location of the local display tool and the activity in the area. For an example, if there is a lecturer presenting a lecture nearby and the sound would be distracting, it would be disabled.

The underlying core of the display unit is the computer, which coordinates the various functions of the unit. In the local display unit embodiment, there is an onboard or nearby computer to run the application via a remote connection with the host server. The system is operable over any operating system (i.e., Windows, Unix, etc.), and will ideally operate over a computer with a small form-factor, so as to be unobtrusive. In one alternative embodiment, the display tool's computer can connect to the host through a non-computer device which would connect to the host through a local internet connection.

It should be noted that although the description of the present invention's preferred embodiment refers to a memorial board example, the board also facilitates specific functionality unique to its other modules. As an example, when used as a Donor board, they system includes unique features such as its ability to switch between campaigns within one board and to track the progress of each campaign visually against each campaign's goal. When functioning as a Life Events board, the system will link various life events (birth, graduation, marriage, birth of children, anniversaries, etc.) for each individual creating a chain of activities and sharing the highlights of the life of the individual within an organization.

### Administrative Tools

Notification and Memorial site design—The present invention includes skins and tools to help users set up notification and memorial sites, which are linked to an organization's site. The site allows visitors to view and interact remotely with the environment.

Each user that wishes to set up a notification or memorial would go through a questionnaire (either online or through an administrator) that allows the user to customize the functionality and rules of their system's environment and allows them to tailor the system's operation and experience to their particular needs. Users determine what rights individuals have within their site and how data is shared with the rest of the system and beyond. They control issues of access, design and control of their online experience as well as that of the display and broadcast tools and unit. As an example, they will have to determine if they wish to enable interactive functionality at the local display tool unit and the degree of that functionality.

The administrative tools of the present invention also enable administrators to batch import member data, to be used to populate various areas of the system, and be available for linking relationships in the system. The administrative tools further empower administrators to expand on the data and content of any individual in the system or create a new individual.

One of the most significant functions of the present invention is the relationships feature. The present invention is able to link users throughout the system's database and records to assist in maintaining integrity of the system and for genealogical searches.

In the preferred embodiment, using the relationship administration feature, visitors to the memorial environment can not only learn more about the deceased, but can also put them in perspective of others within the organization or elsewhere. Currently, when someone looks at a plaque on a memorial board, they see only that individual. This is fine if the visitor knew the deceased. Otherwise, that individual has no association with the visitor. Using the system of the present invention, users and visitors can now relate to the individual through some of their family members who the visitor may know. With relationship administration, the present invention brings individuals from our past into the present through our familiarity with their successors.

The administrative tools of the present invention further include a tool to allow users to accumulate data about their members and affiliated individuals, manage this information, and utilize the data for emails, analysis and other organizational functions. The tool includes a full report generating tool and the ability to generate custom reports and export to report writing, mail merge and analysis programs.

### Communication Tools

### Blog

The present invention further provides users with the ability for to contribute to the memorial of an individual by way of an entry into a public Blog. The Blog will allow anyone who knew the deceased to submit memories, photos, thoughts or other material having to do with the deceased. This will be available for anyone to see in a chronological format and to comment about if they wish to. Optionally, all material will first have to be approved by the creator of the web page to ensure appropriate content. In alternative embodiments, the blog tool will allow users to further discuss and enrich the system's content on related and relevant topics.

In the preferred embodiment, the Blog allows for the separation of material presented by the memorial creator and others. The creator is usually a family member who may not wish to have their presentation clouded by others input. The Blog is a looser structure where they should be accepting of additional material.

### Guestbook

The present invention also includes a guestbook where visitors, associated members, or guests, can convey messages relating to specific notifications or events. In the preferred embodiment, these messages are often directed to the bereaved and are linked directly from the memorial created for the deceased family member. Visitors send condolences, just say they were there, comment on the memorial pages, or request to have material contributed to the memorial pages. Guestbook entries can optionally be emailed to those attached to the memorial pages for one of the deceased, and designated as recipients for that individual.

### Email

An important element of the present invention is the communication tool. The present invention serves as a central communication manager for efficiently disseminating announcements, updates, and relevant information and materials to interested and related parties. The system also enables users to share thoughts and messages between members.

The email tools of the present invention facilitate bi-directional communications between the system, the organization, and the organization's individual members and associates. In the preferred embodiment, this is an internal emailing system which will not allow any external mail, other than those specifically designated, to enter the emailing environment. As a result, the present invention will impede, if not stop, the presence of spam and inappropriate emails.

Through the email tool of the present invention, users receive an email account name and passwords. Mail is distributed within the email system and server. All external email is be blocked from the system. In the preferred embodiment, only internal emails, originating from a source with the specific email address, will be able to reach another email address within the system.

Using this system, organizations can send emails to their membership using their assigned email addresses. Similarly, members are able to send messages directly to other members or organizations.

In an alternate embodiment, while no external emails enter in to the email environment of the present invention, users can send emails to outside email addresses.

In the preferred embodiment, messages from other users are sent to the family of the deceased and presented on the memorial webpages through guestbook messages they send. Those messages are sent to any individuals designated by the bereaved's site as recipients of the emails directed to family members and friends of the deceased.

### Notifications and Reminders

The present invention further includes tools to send out automated notifications and reminders to interested parties of important announcements and reminders. For instance, in the preferred embodiment, death notifications and notification of funeral services are sent out to all members. Reminders of anniversaries are sent to the survivors of the deceased and anyone requesting to be added to the reminder list.

### Webcast and Broadcast Tools

The present invention also includes a system and module that allows events and services to be captured, stored and broadcast over the internet.

In the preferred embodiment, video and audio of the event would be captured on video camera or a high quality webcam and be saved to a computer server rather than being saved on the camera's storage media. Once on the server, the captured video is saved to a file, burned to DVDs, broadcast locally, and/or webcast over the internet.
Saved to a file—Saved files will be available for later viewing by those who were not able to attend the event captured. The file is posted to the web on the relevant system webpage or through any other web posting service, and is also archived and stored in the system.
Burned to DVD—Files are burned to DVD media and are disseminated following the event.
Broadcast locally—If an event is well attended and the crowd overflows into an adjoining room or the hallway, the system of the present invention enables the user to broadcast the event locally in a hallway or an adjoining room.
Webcast—The system of the present invention also enables users to webcast events over the internet. Webcasts are viewed by anyone whom the administrator wishes to allow to access the webcast. The webcast tools of the present invention allow the user to designate their desired level of security.

In the preferred embodiment of the present invention, webcasts are of great benefit to those who are in other parts of the world when a family member or close friend pass away. Issues of delaying a funeral service or financial constraints play a role in their ability to attend. With the webcast tools of the present invention, they do not have to go through such burdens and are still able to participate in the services.

In addition, when a remote individual goes to a funeral home equipped with the webcasting tools of the present invention, they have the option of contributing to a memorial service in another location. As an example, if a funeral service is taking place in Los Angeles and a family member is grounded in New York, that family member can go into a funeral home in New York that offers the webcast functionalities of the present invention and eulogize the deceased in the Los Angeles services via the internet. In an alternative embodiment, the user can utilize any computer equipped with the necessary webcasting equipment (webcam, microphone, etc.).

The webcasting tools of the present invention are also used to present webcasts within other organizations. Since the live webcasts can be displayed remotely via the internet, those who wish to view the webcast in the organization's facility can do so on the display tool of the present invention.

The present invention further includes a tool whereby pictorial and/or multimedia presentations can be presented to and viewed by users simultaneously with a webcast. In one embodiment, the tool will operate to display such multimedia presentations on a screen or other such display device while a eulogy or memorial service is being presented, to further enhance this experience. In an alternate embodiment, remote users who are not physically present at the memorial service are able to view both the webcast of the service, while also viewing the multimedia presentation, in either a split-screen, integrated, or any other such video-display method allowing users to simultaneously view multiple video and/or visual feeds.

### Tribute and Dedication Tools

The present invention also facilitates giving within organizations. The present invention includes tools to handle the receiving of contributions and to help administer the record keeping and communication of gratitude to the contributor. In one embodiment, the present invention can set up PayPal accounts for its users and make giving a smoother experience for the giver.

In the preferred embodiment, the present invention also communicates other dedications such as books and buildings, and the issuance of scholarships in memory of the deceased through its display tools and memorial websites. This bodes well for contributors because awareness of the contributions will be available within the settings they contributed them, as well as being communicated to the world.

### Alternative Embodiments

While the preferred embodiment of the present invention as described is directed towards use in a memorial setting, the systems, technologies, and functionalities of the present invention are applicable in a broad range of industries and settings, such as:
The display tools of the present invention used for general notice boards.
The webcast tools and module of the present invention for lecture and event webcasting.
The administrative tools of the present invention for tracking organizational membership.
The communication tools of the present invention for general organization communication.

In addition, the system and tools of the present invention can be implemented either as a stand-alone product or as one that resides on an organization's server.

Finally, the memorial and community aspects of the present inventions need not be specific to humans. As an example, the system and tools of the present invention may be used to present pets. The general plan would still be to create links between pet owners and pets being presented. However, a community concept would still be necessary whether geographic area, breed, or kennel club groups it.

### Results of Implementing the Present Invention

The implementation of the present invention serves to overcome many of the gaps prevalent in the current memorial offerings available to individuals and organizations. Users that are automatically involved in the organizations that the memorials are tied to will frequently see that the memorial exists without any additional notification. They will see the memorial if they visit the individual's memorial page or on a display device within the organization. The ‘walking through the graveyard’ phenomenon will still exist, but will only supplement the visits from familiar visitors.

The present invention offers a much more complete memorial than all other options, including more effective and comprehensive communication tools and more extensive opportunities for revenue and growth. Additionally, the present invention includes many tools not offered with the other solutions, such as the administrative modules, and the sophisticated display and broadcast tools of the present invention.

In addition, users and administrators gain from the implementation and use of the present invention through revenues that can be generated from the utilization of the various tools and services of the present invention and through sponsorships of such tools and experiences within organizations.

The present invention further improves the ability of family members to enhance the memorialization of their loved one. As the network and database of users and memorials grows, people will seek out information about the deceased they want to find out more about. They will see the contributed material and the contributions made in memory of the deceased and will make their own contributions through the system as well. The tools of the present invention also promote other giving as well by recognizing those contributions within the context of the present invention. So while scholarships, book issues, building dedications and the like are great forms of memorializing within an organization, the present invention can further help in the recognition of the dedication globally.

Finally, the implementation of the present invention will be very affordable compared to the other forms of dedication. Furthermore, the present invention provides users with the widest exposure for memorializing the deceased and contributes the proportionately largest return for the organizations.

What is claimed is:

1. An electronic notification and management system comprising display means for presenting notifications and related media, administration means for deploying and maintaining the system's operation, communication means for disseminating and sharing information among the system's users, broadcast means for recording and projecting related information and media, and dedication means for receiving donations and payments.

2. The system of claim 1, wherein said display means is defined as a monitor.

3. The system of claim 2, wherein said monitor is operatively connected to a central networked computer operating the system's software.

4. The system of claim 2, wherein said monitor is enclosed in a protective enclosure.

5. The system of claim 1, wherein said display means includes input devices for user navigation and interaction.

6. The system of claim 1, wherein said display means further includes audio speakers.

7. The system of claim 1, wherein said administration means is defined as a software program running on the system's computer.

8. The system of claim 7, wherein said administration means includes controls for the look, feel, and operation of the system.

9. The system of claim 7, wherein said administration means further includes database management tools.

10. The system of claim 7, wherein said administration means further includes tools for identifying relationships and connections between data items.

11. The system of claim 7, wherein said administration means further includes data analysis tools for reviewing and managing collected data.

12. The system of claim 1, wherein said communication means is defined as a software program running on the system's main computer.

13. The system of claim 13, wherein said communication means includes a tool for submitting information and media to create and maintain a blog.

14. The system of claim 13, wherein said communication means further includes a tool for submitting information and media to create and maintain a guestbook.

15. The system of claim 13, wherein said communication means includes an email module for electronic communication and correspondence.

16. The system of claim 13, wherein said communication means includes a tool to disseminate automated and scheduled notifications and reminders.

17. The system of claim 1, wherein said broadcast means is defined as an audio and video capture device.

18. The system of claim 17, wherein said audio and video capture device is connected to a computer.

19. The system of claim 17, wherein said broadcast means includes tools for affixing and preserving recorded media.

20. The system of claim 17, wherein said broadcast means are operatively connected to the Internet.

21. The system of claim 17, wherein said broadcast means are operatively linked to other broadcast means via the internet.

22. The system of claim 17, wherein said broadcast means includes presentation means for alternative media and file types.

23. The system of claim 1, wherein said dedication means includes a software program running on the system's computer.

24. The system of claim 23, wherein said dedication means includes tools for giving and receiving payment and recognition.

25. An electronic notification and management method, comprising the steps of: displaying notifications and related media, administrating and maintaining the system's operation, communicating and sharing information among users, broadcasting and recording related information and media, and dedicating and receiving donations and payments.
